(19) United States
(12) Patent Application Publication
(10) Pub. No.: US 2014/0311245 A1
(43) Pub. Date: Oct. 23, 2014

(54) PIPE INSPECTION SYSTEM AND RELATED METHODS

(71) Applicant: ACOUSTIC SENSING TECHNOLOGY (UK) LTD, Cheshire (GB)

(72) Inventors: Kirill Vjacheslavovitch Horoshenkov, Ilkley (GB); Simon Joseph Tait, Haworth (GB); Mohammad Tareq Bin Ali, Huddersfield (GB)

(73) Assignee: ACOUSTIC SENSING TECHNOLOGY (UK) LTD, Cheshire (GB)

(21) Appl. No.: 14/257,308

(22) Filed: Apr. 21, 2014

Related U.S. Application Data
(60) Provisional application No. 61/813,792, filed on Apr. 19, 2013.

(30) Foreign Application Priority Data
Jul. 11, 2013 (AU) AU 2013902561
Apr. 16, 2014 (GB) PCT/GB2014/051193

(51) Int. Cl. G01N 29/36

(52) U.S. Cl. CPC G01N 29/36
USPC 73/592

(57) ABSTRACT

The present invention provides an improved pipe inspection system and related methods. In one embodiment, the invention provides an airbourne acoustic pipe inspection system and method. The present invention further comprises a non-transitory computer-readable medium storing executable computer program code for inspecting pipes.

### CROSS-REFERENCE TO RELATED APPLICATION

This application claims the benefit of and priority to a U.S. Provisional Patent Application No. 61/813,792 filed Apr. 19, 2013, the technical disclosure of which is hereby incorporated herein by reference.

This application claims the benefit of and priority to Australian Patent Application No. AU 2013902561 filed Jul. 11, 2013, the technical disclosure of which is hereby incorporated herein by reference.

This application claims the benefit of and priority to International Patent Application No. PCT/GB2014/051193 filed Apr. 16, 2014, the technical disclosure of which is hereby incorporated herein by reference.

### TECHNICAL FIELD OF THE INVENTION

The present invention provides a pipe inspection system and related methods. In particular, but not exclusively, the invention relates to the airbourne acoustic inspection of pipes.

### SUMMARY OF INVENTION

An example system suitable for the performance of the airbourne acoustic inspection of pipes is shown in EP07985508, now assigned to Acoustic Sensing Technology (UK) Ltd.

Embodiments described herein aim to provide an improved method and apparatus.

According to a first aspect of the invention there is provided a method of inspecting pipes, the method comprising deploying an apparatus in a pipe and performing at least one and possibly more of the following steps;
emitting an acoustic signal from the apparatus;
detecting reflected acoustic signals with a detector array of the apparatus and
determining the an acoustic intensity from the reflected acoustic signals;
analysing the acoustic intensity to determine an acoustic signature of the pipe that is being inspected;
storing in a library or comparing the acoustic signature against a library of previously determined acoustic signals; and
determining, from the comparison, the condition of the pipe being inspected.

According to a second aspect of the invention there is provided an apparatus arranged to inspect a pipe, wherein the apparatus comprises one or more of the following:
a sound emitter typically arranged to emit an acoustic signal;
a detector array typically configured to detect acoustic signals;
a signal processor which may be arranged to
   i) determine the acoustic signature of a pipe that is, in use, being inspected;
   ii) compare the acoustic signature against more than one library of previously determined acoustic signals; and
   iii) determine, from the comparison, the condition of a pipe being inspected.
   iv) use the majority of odds method to optimise the decision on the pipe condition.

According to a third aspect of the invention there is provided a non-transitory computer-readable medium storing executable computer program code for inspecting pipes, to computer program code executable to perform steps comprising:
emitting an acoustic signal from the apparatus;
detecting reflected acoustic signals with a detector array of the apparatus and
determining the an acoustic intensity from the reflected acoustic signals;
processing the acoustic pressure signals to convert them to the intensity to determine an acoustic signature of the pipe that is being inspected;
comparing the acoustic signature against a library of previously determined acoustic signals; and
determining, from the comparison, the condition of the pipe being inspected.

The machine readable medium (which may be thought of as a computer readable medium) of any of the aspects of the invention may comprise any one or more of the following: a floppy disk, a CDROM, a DVD ROM/RAM (including +RW, −RW), an HD DVD, a BLU Ray disc, a hard drive, a non-volatile memory, any form of magneto optical disk, a wire, a transmitted signal (which may comprise an internet download, an ftp transfer, or the like), or any other form of computer readable medium.

The skilled person will appreciate that a feature described in relation to any one of the above aspects of the invention may be applied, mutatis mutandis, to any other aspects of the invention.

### BRIEF DESCRIPTION OF THE DRAWINGS

There now follows by way of example only a detailed description of an embodiment of the present invention with reference to the accompanying drawings in which:

FIG. 1 (Prior Art) shows an apparatus suitable for performing the present invention;

FIG. 2 shows the components of an apparatus according to an embodiment;

FIG. 3 (Prior Art) shows an output from an embodiment for a clean 14.8 m long pipe;

FIG. 4 shows an example of an intensity-based acoustic signature, shown as a spectrogram, generated in an embodiment of the invention and representing a typical pipe end;

FIG. 5 shows a further example of acoustic signatures, shown as an acoustic intensity spectrogram, and representing a blockage within the pipe at 8.0 m with the pipe end signature visible at 14.8 m;

FIG. 6 shows an example of an acoustic signature, shown as a spectrogram, for a pipe with a 15 mm high blockage in the presence of flow with 1.00 l/s discharge;

FIG. 7 shows a state lattice used to find forward/backward recursions in generating a Hidden Markov Model;

FIG. 8 shows characteristic signatures for a pipe end for three particular frequency bands;

FIG. 9 shows characteristic signatures for a blockage for three particular frequency bands;

FIG. 10 shows characteristic signatures for lateral connections for three particular frequency bands;

FIG. 11 shows the short term acoustic energy calculated in the first frequency band; and

FIG. 12 shows a flow chart outlining the method of an embodiment.

### DETAILED DESCRIPTION OF THE INVENTION

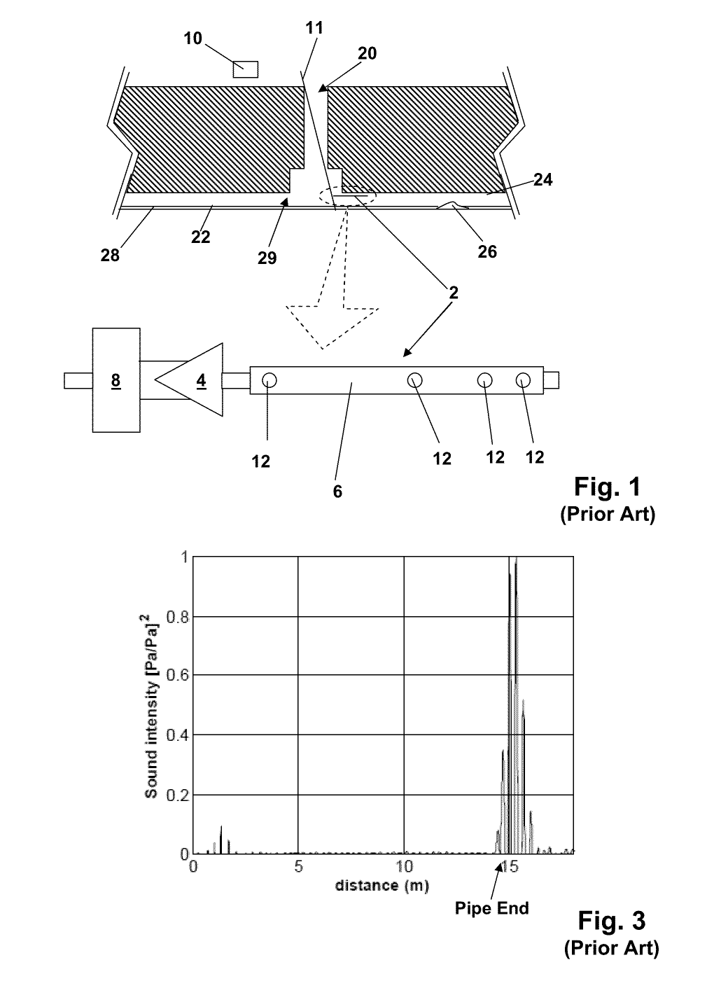

It is convenient to describe embodiments in relation to the inspection of sewer pipes but use of embodiments is not so limited and may find applicability in other fields. The water industry, such as is relevant to sewer pipes, uses mathematical models for water pipes (including sewer pipes) to predict flow depth, velocity and hydraulic capacity. These mathematical models are tools in the design process for rehabilitating existing ageing pipes and assessing their propensity for flooding and discharges to watercourses. Bed sediments, pipe obstructions and general pipe roughness can considerably affect the theoretical predictions so that embodiments may be used to improve the knowledge of the in-pipe conditions which these predictions are designed to simulate. Referring to FIG. 1 there is shown an apparatus 2 for the airborne acoustic inspection of pipes. It is convenient to describe the inspection in relation to sewer pipes but other embodiments may find utility in other fields.

Airbourne acoustic inspection of pipes relies on the analysis of acoustic signals that are reflected by various types of irregularities typically found in a pipe which is either dry or only partially filled with water. These reflections carry sufficient information to identify structural defects, sediment blockages, lateral connections, pipe ends, the level of water which this pipe carries and the like. Embodiments described herein rely on acoustic intensity data which is a vector whose direction is perpendicular to the wave front, i.e. the direction in which the acoustic energy propagates. This vector quantity is sensitive to the changes in the medium properties and to the changes in the boundary conditions along the path of the sound wave. Sudden changes in the medium properties result in acoustic reflection and scattering. An advantage of embodiments employing this acoustic intensity approach is that they can be used to separate waves reflected in a particular direction and may also compensate partially for the influence of the manhole environment on the quality of acoustic data used for pipe condition classification.

The apparatus 2 (see FIG. 1) comprises a loudspeaker 4 (which may be thought of as a sound emitter) configured to emit an acoustic signal, a detector array 6 configured to detect acoustic signals and a signal processor unit 8 configured to determine an acoustic intensity from the detected acoustic signals. The signal processor unit 8 may be a mobile computer (e.g. a laptop) 10 in data communication with the detector array 6. The data communication may be via a physical cable (such as a Universal Serial Bus USB; a Firewire connection, Thunderbolt connection, short range wireless communication (e.g. Bluetooth™), etc. The acoustic intensity can be analysed and/or represented graphically to identify blockages and intrusions in the pipes.

In other embodiments, the signal processor 8 may be provided by other types of processing circuitry other than a laptop 10. For example, the signal processor 8 may be provided by mobile telephone (such as an iPhone™; and Android™ phone; a Blackberry™); a PDA; an iPad or tablet, or the like. In some embodiments, the signal processor 8 may be provided by a dedicated apparatus.

The apparatus 2 is mounted on a pole 11 (only part shown) whereby the apparatus 2 can be lowered down a man-hole by a user at surface level. The pole is typically extensible,

The detector array 6 comprises a horizontal array of two or more, in this case four, MicroElectrical-Mechanical System (“MEMS”) microphones 12 arranged on a slim Printed Circuit Board (“PCB”) 14 covered by a protective but acoustically transparent screen 15. Other embodiments may use other forms of transducer in order to detect the acoustic signals.

The microphones 12 are spaced at distances which are much less than λ/5, where λ is the acoustic wavelength at the maximum frequency in the acoustic spectrum of interest. Each microphone 12 has an associated microphone channel to output its received signal to the signal processor 8. The detector array 6 is installed and mounted in front of the loudspeaker 4 at a distance of less than 0.5 m from the loudspeaker diaphragm. Other embodiments may space the detector array 6 at a different distance from the loudspeaker.

The Figure shows the apparatus 2 at the bottom of a manhole 20 in a sewer pipe 22 in which there are perforations and cracks at 24 and a blockage at 26. The water level in the sewer pipe 22 is indicated at 28 and air, through which the acoustic signals are propagated, is above the water and indicated generally by numeral 29. A typical sewer runs about 20% full of water.

Embodiments are typically used to inspect pipes in the dry flow conditions, i.e. when the level of water is relatively low, a large proportion of the pipe circumference is relatively dry and it can be inspected with airborne acoustic waves. There exists a mismatch between the impedance of air and that of the pipe wall material and therefore the coupling between the airborne waves and structure-borne waves in the pipe wall is small and can be neglected in a model which can be used to describe the acoustic intensity within the pipe being inspected 22. In this way, the acoustic wave reflections which occur due to the cross-sectional changes and wall impedance variation can be timed in terms of the airborne wave velocity.

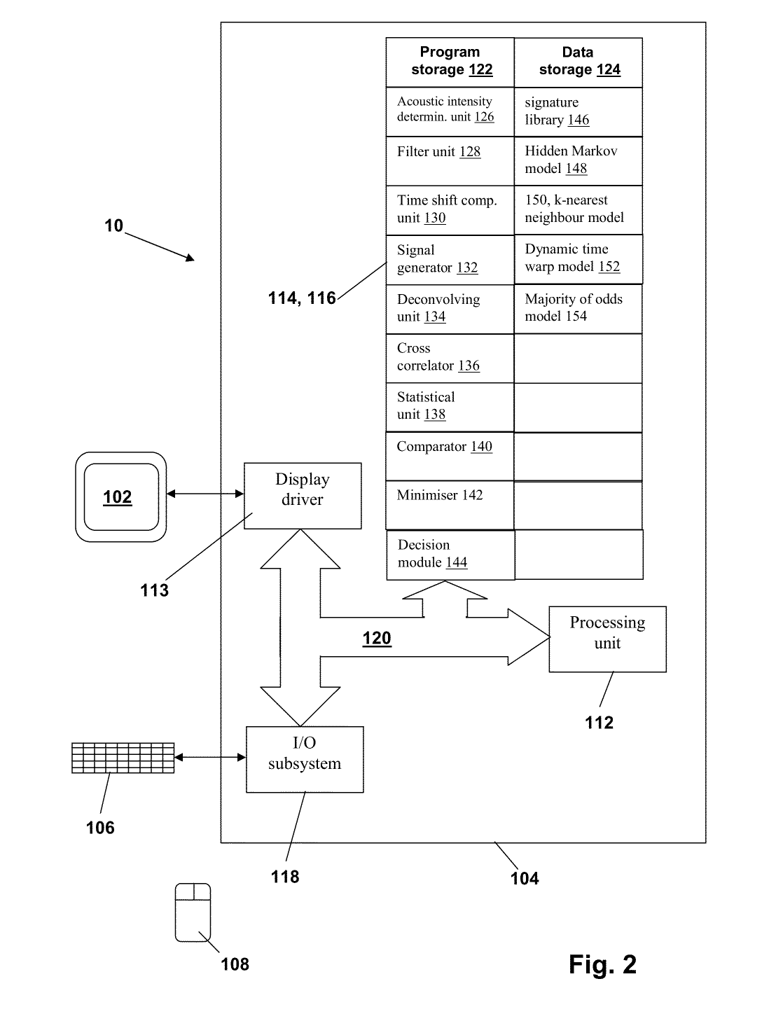

The computer system of FIG. 2 (which may be the mobile computer 10) is arranged to implement an embodiment and comprises a display 102, processing circuitry 104, a keyboard 106 and a mouse 108. The skilled person will appreciate that in other embodiments the mouse 108 may be replaced or be used in addition to other input devices such as track-pads; track balls, touch screens or the like.

The processing circuitry 104 comprises a processing unit 112, a graphics system 113, a hard drive 114, a memory 116, an I/O subsystem 118 and a system bus 120. The processing unit 112, graphics system 113 hard drive 114, memory 116 and I/O subsystem 18 communicate with each other via the system bus 120, which in this embodiment is a PCI bus, in a manner well known in the art.

The processing unit 112 may comprise a processor such as an Intel™ i3™, i5™ or i7™ processor or may comprise an AMD™ Bulldozer™ or Bobcat processor, or the like.

In at least some embodiments, the graphics system 113 comprises a dedicated graphics processor arranged to perform some of the processing of the data that it is desired to display on the display 102. Such graphics systems 113 are well known and increase the performance of the computer system by removing some of the processing required to generate a display from the processing unit 112.

It will be appreciated that although reference is made to a memory 116 it is possible that the memory could be provided by a variety of devices. For example, the memory may be provided by a cache memory, a RAM memory, a local mass storage device such as the hard disk 114, any of these connected to the processing circuitry 104 over a network connection. However, the processing unit 112 can access the memory via the system bus 120 to access program code to instruct it what steps to perform and also to access data to be processed. The processing unit 112 is arranged to process the data as outlined by the program code.

A schematic diagram of the memory 114, 116 of the processing circuitry is shown in FIG. 2. It can be seen that the memory comprises a program storage portion 122 dedicated to program storage and a data storage portion 124 dedicated to holding data. The skilled person will appreciate that in reality there may be no distinct segregation between the various components as shown in the Figure.

The program storage portion 122 comprises an acoustic intensity determining unit 126, a filter unit 128, time shift compensation unit 130, a signal generator 132, a deconvolving unit 134, a cross-correlator 136, a statistical unit 138, a comparator 140, a minimiser 142, a decision module 144 and a majority of odds vote model which can be used to maximise the probability of correct condition classification with any of the methods outlined herein. All of these may be thought of as modules and the function of these is described below.

The data storage portion 124 comprises one or more signature libraries 146 which can include hidden Markov models 148, k-nearest neighbour algorithm model 150, dynamic time warping model 152.

Embodiments of the invention use the acoustic intensity probe as described in relation to FIG. 1 which allows the direction of the acoustic intensity to be determined Whilst the process of using this probe is described below, more detail can be found in EP07985508 and the skilled person is directed to read this document, to obtain further details of the apparatus, which is hereby incorporated by reference. Embodiments calculate the instantaneous acoustic intensity vector, which is carried out by combining the acoustic pressure signals from the microphones 12 arranged in the array on the apparatus 2. The acoustic intensity determining unit 126 is typically provided to perform this calculation.

The instantaneous intensity vector is given by the following expression

$$\tilde{I} ( t ) = p ( t ) u ( t ) , u ( t ) = - \frac{1}{{ρ}_{0}} {\int }_{- ∞}^{t} \frac{\partial p}{\partial n} d τ \qquad ( 1 )$$

where u(t) is the time-dependent acoustic (particle) velocity vector, n the normal that coincides with the direction of sound propagation and p(t) is the acoustic pressure measured at the receiver position. The main difficulty here is to determine the exact value of the

$$\frac{\partial p}{\partial n}$$

quantity and its approximate value is commonly used so that equation (1) may be re-written as

$$p ( t ) \approx \frac{{p}_{1} ( t ) + {p}_{2} ( t )}{2} \\ and \\ u ( t ) \approx - \frac{1}{{Δρ}_{0}} {\int }_{- ∞}^{t} [ {p}_{1} ( τ ) - {p}_{2} ( τ ) ] d τ , \qquad ( 2 )$$

where pₘ(t) and pₙ(t) are the sound pressures measured on two microphones 12 in the array 6 that are separated by the distance Δ<<λ, λ being the acoustic wavelength.

Sound propagation in a cylindrical pipe 22 above the frequency of the 1st cross-sectional mode is a dispersive phenomenon. In this frequency range sound waves can propagate in directions other than normal with respect to the cross-section of the pipe 22, and the sound pressure depends strongly on the source and receiver positioning. Accordingly, embodiments of the invention may be arranged to limit the frequency of the sound emitted from the loudspeaker 4 to the frequency range below the first cut-off frequency of the pipe. In this way, the sound pressures recorded with the microphone array 6 can be conditioned and filtered in several narrow frequency bands using a suitable digital filter (possibly by the filter unit 128). The intensity response between microphone m and microphone n in the microphone array can then be determined for each individual frequency band according to expression (2). The result can be divided by the norm, i.e.

$$‖ {I}_{mn} ‖ = {max}_{t \leq {T}_{0}} [ - {I}_{mn} ( t ) ] \qquad ( 3 )$$

where Tₒ being some time limit which relates to the duration of the incident pulse. This normalisation procedure ensures that the maximum intensity in the incident sound wave is equal to or greater than −1. It can be seen on the vertical axis of FIG. 3 that the values range from 0 to 1. In the case, used in some embodiments of the invention, when the microphone array 6 is linear and it is orientated in the direction of plane wave propagation, the normalised intensity response for individual microphone pairs can be compensated for the time shift, τₘₙ. This time shift is present in the intensity response because of the variable distance from the speaker 4 diaphragm to the centre of a microphone pair in the array, i.e.

eₘₙ(t)=Iₘₙ(t+τₘₙ)/∥Iₘᵢₙ∥. (4)

The normalized and time-shift compensated intensity responses for several microphone pairs can then be combined coherently to obtain the mean intensity response function

$$e ( t ) = {\sum }_{m , n} {e}_{mn} ( t ) \qquad ( 5 )$$

The time shift compensation unit 130 is typically arranged to perform this time shift. In this regard it is noted that the microphones 12 within the array 6 are positioned at varying distances from one another which increases the number of microphone pairs within the array 6 due to the unrepeated distances separating the microphones 12.

In this way the effects of sound reflection from the pipe termination near the acoustic instrument and mismatch errors are reduced. Some embodiments may be arranged to only use the positive (reflected) part of the mean intensity response function (5) for the pipe condition characterization which represents the sound intensity reflected from the irregularities in the pipe, i.e.

e⁺(t)=(e(t)+|e(t)|)/2. (6)

Some embodiments use a sine chirp (step 1200) as an excitation signal, which is created by the signal generator 132. Typically, the sine chirp has a constant amplitude. Such embodiments are felt advantageous as such a chirp is time-invariant and it is less prone to harmonic distortions and as such is well suited for measurements in the presence of a dynamically rough water surface and high levels of background noise.

The instantaneous frequency sweep was defined by the following equation (7).

$${f}_{i} ( t ) = {f}_{start} \times {β}^{t} , β = {( \frac{{f}_{stop}}{{f}_{start}} )}^{\frac{1}{{t}_{1}}} . \qquad ( 7 )$$

Here, fₛₜₐᵣₜ and fₛₜₒₚ is the start frequency and stop frequency in Hz and t₁ is the duration of the chirp in seconds. In other embodiments, other signal waveforms may be used as the excitation signal to drive the loudspeaker 4. For example, other embodiments may use a maximum length sequence, pseudo-random noise or the like.

Once received on a microphone 12, this signal is deconvolved, by the deconvolving unit 134, to obtain an acoustic pressure impulse response (step 1202). An example of the resultant acoustic intensity response calculated for a clean 150 mm pipe from equation 6 is shown in FIG. 3. A reflection from the pipe end is visible in the intensity response at 14.8 m. In this Figure, the intensity response is shown for the 150-300 Hz range; one of the frequency bands created in the initial filtering performed in some embodiments (step 1204).

Once the signal has been filtered into the desired bands, the signal from a plurality of microphones 12 is combined to generate the acoustic intensity (the vector quantity) step 1206.

Thus, the acoustic intensity is now obtained for what might well be the entire length of the pipe 22 being inspected. However, much of this acoustic intensity does not contain information of interest, since there may well be no features in the pipe (i.e. defects, pipe ends, lateral connections, blockages, or the like). Accordingly some embodiments are arranged to derive portions of the acoustic intensity, which portions relate to a feature of the pipe. Such embodiments, can significantly reduce the amount of data that has to be processed, thereby speeding up the process and/or reducing the power of the hardware needed to perform the method.

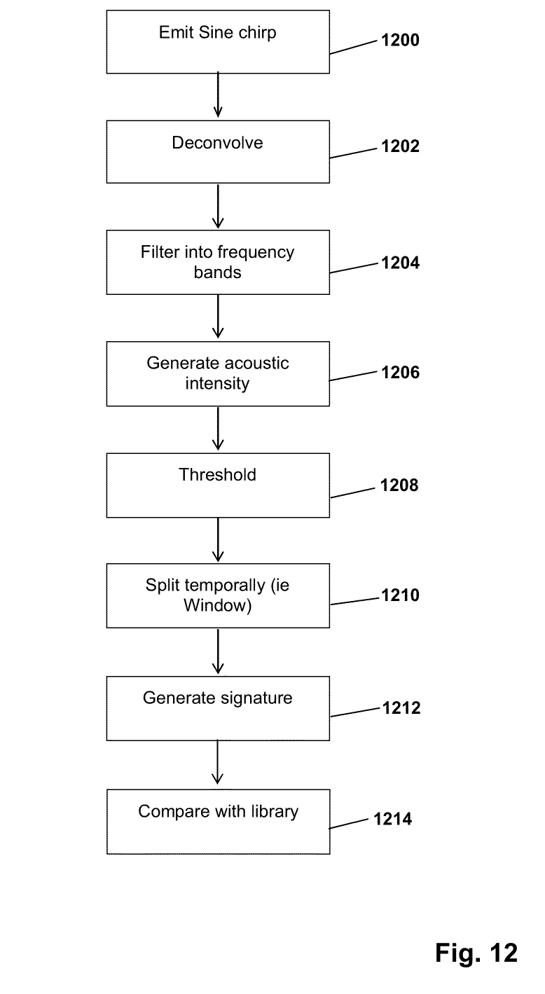

In the embodiment being described the derivation of the portions is carried out by thresholding the acoustic intensity such that any data that has an amplitude of greater than 10% of the maximum signal is held to relate to a feature within the pipe (step 1208 of FIG. 12). Thus embodiments may comprise a thresholding unit. Further embodiments may use a threshold of other than 10%. For example, other embodiments may use a threshold of 2.5%, 5%, 7.5%, 15%, 20% or 25% or the like (or any value in between these).

Thresholding in this manner may be thought of as splitting the acoustic intensity into one or more portions of the acoustic intensity signal; that is it divides the acoustic intensity temporally (step 1210).

Other embodiments may use other techniques for generating the portions of the acoustic intensity. Other embodiments may use an adaptive method using a sliding time window to select the intensity data to be cross-correlated with a signature from a signature library. This method may be used to adjust the settings in the thresholding unit so that the weak reflected signals are not omitted from the analysis. This can be achieved in two steps. The first step is to determine the normalised temporal correlation function γₙ(τ)=E{(e⁺(t)−μ)(eₛ⁺(t−τ)−μₛ)}/(σσₛ), where E{ } is the mathematical expectation, e+(t) is the measured intensity within the limits of the adopted time window, eₛ⁺(t) is the signature from the signature library, σ is the standard deviation in the measured intensity signal and aσₛ is the standard deviation in the intensity signal in the signature. If the maximum value of γₙ(τ) a, where 0<a<1 is some arbitrary parameter, then one can assume that the signals are somewhat correlated. The step two is then to adopt the value of σ as a measure of the new threshold which needs to be set in thresholding unit to ensure that this part of the signal is analysed against a signature library of defects.

Embodiments may then be arranged to generate an acoustic signature for at least some of, and typically each, of the portions of the acoustic intensity signal (step 1212).

As described hereinafter, these acoustic signatures can be used to determine the features of the pipe 22 (step 1214).

In some embodiments, analysis of the acoustic signature can be used to determine if further or more detailed inspection of the pipe 22 is required. For example, if analysis of the acoustic signature confirms that the pipe 22 is in good condition, no further inspection is required. However, if, for example, analysis shows that the pipe 22 is damaged, further inspection is carried out.

The more detailed inspection can be, for example, by CCTV. Previously, all pipes were inspected by CCTV but inspection by CCTV may be a relatively time consuming process. Therefore, at least some embodiments have the advantage that they save time by removing the need to inspect all pipes by CCTV.

In at least some embodiments, the processing unit 112 may be arranged to generate result files. The result files may include the acoustic signature and/or the condition of the pipe determined from analysis of the acoustic signature. The result files may be stored in the data storage 124 of the processing unit 114 or separate central memory. In at least some embodiments, the result files may be sufficiently small to allow a large number of files to be collected and stored.

In at least some embodiments, a particular pipe may be inspected from time to time. Such inspections may be periodic and perhaps at regular periods. Analysis of a single acoustic signature allows existing defects, for example blockages, to be identified whilst comparison of the result files generated from the same portion of pipe 22 at different times allows for monitoring of the general pipe 22 condition, for example, degradation in the material of the pipe 22.

The interval between inspections may be three months, six months or twelve months, although any period may be used. Comparison of the result files from different inspections allows possible structural defects to be identified before they become critical. In addition, the duration of time until the pipe needs to be inspected can be determined, based on the comparison of result files. In this way, the comparison of output files corresponding to the same portion of pipe can be used to optimise asset management. It will be understood that the pipe may be inspected at any time, and not just at the scheduled period.

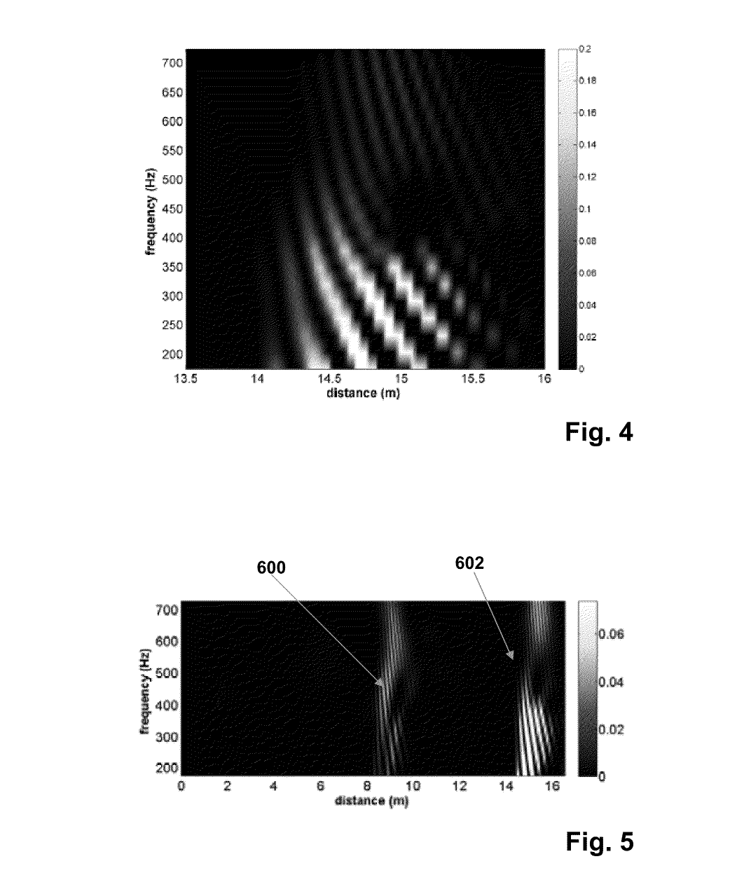

FIG. 4 shows an example acoustic signature (i.e., the acoustic reflection) of a pipe end presented as a spectrogram, in which the acoustic intensity is shown a colour (shown in greyscale in this Figure) on a graph of frequency vs. distance where the colour (or in this case, the greyscale, provides an indication of the intensity as a frequency/distance pair). It will be seen that the spectrogram shown in FIG. 4 relates to a portion of the pipe 22 between 13.5 m and 16 m from the loudspeaker 4. Accordingly, FIG. 4 shows a spectrogram for portion of the acoustic intensity signal received generated from the signal received by the array 6. In the embodiment being described, the acoustic signature is specifically for a clay pipe and the signature may change according to the material of the pipe, typically because the roughness of the material will vary.

Some embodiments of the invention are arranged to collect a number of acoustic signatures and to construct the signature library 140 (a database) which can then be used with a suitable statistical method or other suitable pattern recognition technique programmed to recognise a particular condition. In particular one or more of the following may be utilised by embodiments: cross-correlation possibly in the time and/or frequency domains (performed by a cross correlator 136), Hidden Markov models, dynamic time warping.

Embodiments may arrange the signature library such signatures are provided for a range of pipe diameters and/or a range of pipe materials. The skilled person will appreciate that each of these variables will affect the signature. In use, a user may be able to specify these variables in order to reduce the search space in which a signature is compared against the library.

### Hidden Markov Models

In embodiments that use a Hidden Markov Model (HMM), a training process can used to generate the HMM's if the HMM's have not previously been generated. The signature of an irregularity in a pipe can be used as the physical process which can be described probabilistically with a hidden Markov model (HMM) which may be performed by a statistical module 138. The statistical properties of the reflected sound wave undergo a series of transitions and different spectral patterns which can associate with different type of irregularity and other conditions present in the pipe at the time of measurement. These spectral and temporal patterns can be characterized by distinctly different statistical properties, which are in turn reflected in transitions of the defect signal from one statistical state to another.

Should the training process be performed a Hidden Markov Model becomes associated with a particular defect, lateral connection, pipe end, or other feature of the pipe. In order to create a HMM, some embodiments (and possibly the statistical units 138) are arranged to guess the number of sources that emit observation and the number of states with which these sources can be associated. Each state is an emitting source statistically described by the respective probability density function. Therefore, the probability density describing each of these states is b(k|i)=P(yₜ=k|xₜ=i) where i=1, 2, . . . , S, S is the number of states, xₜ is the state random process 1≦k≦K is the number of distinct observation symbols per state, yₜ is the observation random process. Since the process undergoes random jumps from one state to another, the model should also have access to the set of state transition probabilities, a(i|j)=P(xₜ=i|xₜ₋₁=j) where i, j=1, 2, . . . , S, and P(i|j) is the probability of the system jumping from state j to state i. Finally, since any observation sequence must have an origin, embodiments should know the probability of the first observation being emitted by state i. The K-by-S observation probability matrix, B, the S-by-S state transition matrix, A, and the initial probability matrix, π, are then given by

$$B = ( \begin{matrix}P ( 1 \vert 1 ) & … & P ( 1 \vert S ) \\ ⋮ & ⋱ & ⋮ \\ P ( K \vert 1 ) & … & P ( K \vert S )\end{matrix} ) , \\ A = ( \begin{matrix}P ( 1 \vert 1 ) & … & P ( S \vert 1 ) \\ ⋮ & ⋱ & ⋮ \\ P ( 1 \vert S ) & … & P ( S \vert S )\end{matrix} ) \\ and \\ π = ( \begin{matrix}P ( 1 ) \\ … \\ P ( S )\end{matrix} ) . \qquad ( 8 )$$

During the period of training a given HMM is taught the statistical makeup of the observation strings for its dedicated defect. In order to train a HMM the two model parameters, S and K, and three probability matrices, B, A and π (shown in equation (8)), are adjusted to maximize the likelihood P(y|λ_{w}), which is the probability of the observation sequence y={y₁, y₂, . . . , y_{T}}, given the model λ_{w}.

It is assumed that if I={i₁, i₂, . . . , i_{T}} denotes a specific state sequence, then the likelihood can be found from the following expression.

$$P ( y \vert λ ) = {\sum }_{I} P ( y , I \vert λ ) = {\sum }_{i = 1}^{S} α ( {y}_{1 , t} , i ) β ( {y}_{t + 1 , T} \vert i ) \qquad ( 9 )$$

This process can be illustrated using the lattice shown in FIG. 7. Here α(y_{1,t},i) is the joint probability of having generated the partial forward sequence y_{1,t} and having arrived at the state at the t-th step and β(y_{t+1,T}|i) is the probability of generating the backward partial sequence y_{t+1,T}, given that the state sequence emerges from state i at time t. α and β are defined by the following equations

$$\begin{matrix}α ( {y}_{1 , t} , i ) = {\sum }_{j = 1}^{S} α ( {y}_{1 , t - 1} , j ) α ( i \vert j ) b ( {y}_{t} \vert i ) & ( 10 ) \\ α ( {y}_{1 , t} , i ) = P ( {x}_{1} = i ) b ( {y}_{1} \vert i ) & ( 11 ) \\ β ( {y}_{t + 1 , T} \vert i ) = {\sum }_{j = 1}^{S} β ( {y}_{t + 2 , T} \vert j ) a ( j \vert i ) b ( {y}_{t + 1} \vert j ) & ( 12 )\end{matrix}$$

In order to avoid underflow errors in the computations of the forward/backward recursions, α and β is scaled in each step with cₜ.

$$\begin{matrix}β ( {y}_{T + 1 , T} \vert i ) = 1 , & ( 13 ) \\ {c}_{t} = {( {\sum }_{i = 1}^{S} \hat{α} ( {y}_{1 , t} , i ) )}^{- 1} & ( 14 ) \\ \hat{α} ( {y}_{1 , t} , i ) = {c}_{t} \hat{α} ( {y}_{1 , t} , i ) , \\ \hat{β} ( {y}_{t + 1 , T} \vert i ) = {c}_{t} \hat{β} ( {y}_{t + 1 , T} \vert i ) . & ( 15 )\end{matrix}$$

The forward and backward (F-B) re-estimation algorithm can be used for computing a Hidden Markov Model, λ, corresponding to a local maximum of the likelihood P(y∥λ). The algorithm takes a model λ=(B,A,π) and the training observation, y=y_{1,T}, to compute a new model, λ̅=( B̅, Ā, π̅) by the following expressions:

$$\begin{matrix}\overline{a} ( j \vert i ) = \frac{{\sum }_{t = 1}^{T - 1} \hat{α} ( {y}_{1 , t} , i ) a ( j \vert i ) b ( {y}_{t + 1} \vert j ) \hat{β} ( {y}_{t + 2 , T} \vert j )}{{\sum }_{t = 1}^{T - 1} \hat{α} ( {y}_{1 , t} , i ) \hat{β} ( {y}_{t + 1 , T} \vert i )} & ( 16 ) \\ \overline{b} ( k \vert j ) = \frac{{\sum }_{{y}_{t} = k , t = 1}^{T} \hat{α} ( {y}_{1 , t} , j ) \hat{β} ( {y}_{t + 1 , T} \vert j )}{{\sum }_{t = 1}^{T - 1} \hat{α} ( {y}_{1 , t} , j ) \hat{β} ( {y}_{t + 1 , T} \vert j )} & ( 17 ) \\ \overline{π} = \frac{\hat{α} ( {y}_{1 , 1} , i ) \hat{β} ( {y}_{2 , T} \vert i )}{{c}_{1}} . & ( 18 )\end{matrix}$$

For a given tolerance, ε, if the likelihood becomes such that P(y| λ̅)−P(y|λₘ)≧ε then the model is re-estimated with λₘ= λ̅. From equation (16), the required likelihood from any time slot in the lattice can be obtained from the expression

$$P ( y \vert {λ}_{m} ) = {\sum }_{i = 1}^{S} α ( {y}_{1 , T} , i ) = {( {\prod }_{τ = 1}^{T} {c}_{τ} )}^{- 1} . \qquad ( 19 )$$

Finally, in case P(y|λₘ) becomes very small, the logarithmic measure of the likelihood can be used

$$log P ( y \vert {λ}_{m} ) = - {\sum }_{τ = 1}^{T} log {c}_{τ} . \qquad ( 20 )$$

Embodiments may be arranged to use a HMM, λ=(B,A,π), and examine whether the probability (likelihood) P(y|λₘ) is sufficiently high for this model to represent the observation sequence, y={y₁, y₂, . . . , y_{T}}; i.e., the acoustic signature derived from the array 6. Thus, embodiments assume that one of the existing hidden Markov models 146 which are held in the data storage portion of the memory 124 would be able to reproduce the pattern in the data recorded by the array 6. In the case of sound propagation in a pipe with a defect, the acoustical signature of this defect is associated with the HMM via the highest likelihood for which the defect can be recognized.

As discussed above, some embodiments use the signal processor 8 to sample and filter, using the filter unit 128, the intensity responses into three frequency ranges which can be used as an input for training or comparison against the HMM held within the library 148. It will also be appreciate that the discussion of frequency ranges and sampling is applicable to embodiments other than those using the HMM.

In the embodiment being described, the following frequency ranges were adopted, in step 1204 of FIG. 12, to define the characteristics of the reflected signals: (i) 300-450 Hz; (ii) 450-600 Hz; and 600-750 Hz. The skilled person will appreciate that in other embodiments different frequency ranges may be used or indeed, more or less frequency ranges might be used.

Embodiments may be arranged to determine the frequency bands according to the pipe diameter. Embodiment may achieve this by reducing the maximum frequency in the filter bands to just below or just above the frequency of the first cross-sectional resonance of the pipe.

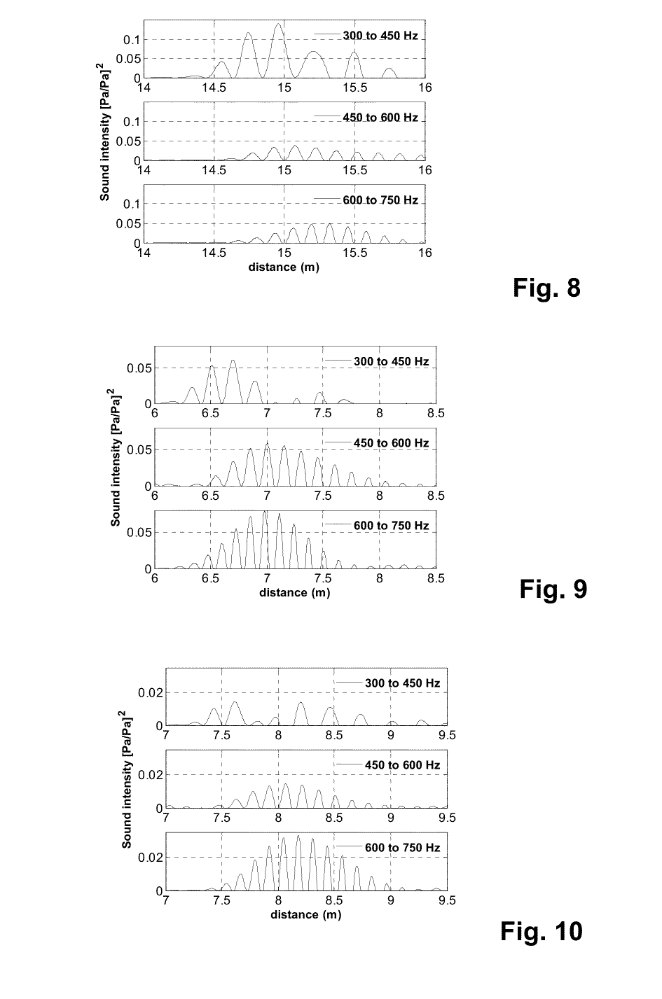

FIGS. 8-10 illustrate the temporal behavior of the positive part of the mean intensity response function (equation (4) above) with each of these figures showing the three frequency bands selected in this embodiment.

It is noted that there are discernible 5-6 fold differences in terms of the sound intensity amplitude as a function of time and frequency when comparing the data shown in FIGS. 8, 9 and 10. These differences can be used in a condition classification algorithm, e.g. the classification algorithm based on the hidden Markov models which can be developed and stored in the database prior to the analysis.

The embodiment being described is arranged to sample the three frequency bands at a frequency of which is at least 2.5 time higher than the maximum frequency of the sine sweep signal emitted in the pipe by the speaker 4 (e.g., 44.1 kHz). Here 600 samples were used in the analysis. In other embodiments the signal processor 8 (and components thereof) may be arranged to use sample lengths of other than 600 samples. The skilled person will appreciate that the number of samples is a balance between accuracy and processing time.

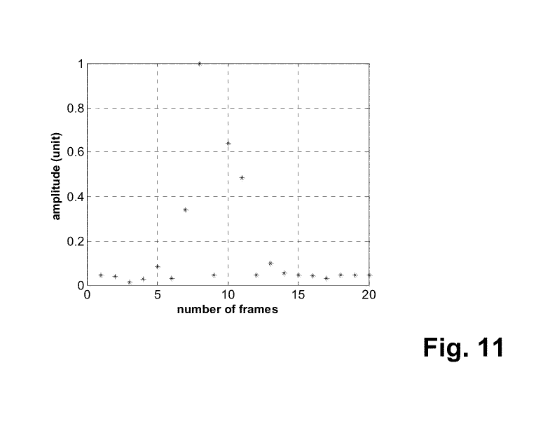

These 600-sample long sound intensity data were selected and split into 20 short data frames of 30 data samples whose duration corresponded to 680 μs. The start of each of these frames was chosen to ensure that the reflected data (i.e., a portion of the reflected intensity signal used to generate a signature) is contained within this time window. Short-time energy for each of these frames are defined as

$$E ( {t}_{0} , ω ) = ( 1 / L ) {\int }_{{t}_{0}}^{{t}_{0} + L} {\{ {e}^{+} ( t , ω ) \}}^{2} d t , \qquad ( 21 )$$

where, L=13.6 msec is the total length of the 600-sample frame. This characteristic was used to derive observation vectors which were used to construct an HMM with y_{i,j}=E(t₀,ω). A result of this process is illustrated in FIG. 11. Once the features of the signal are extracted, k-means algorithm can be applied.

Other embodiments may use a length other than 13.6 msec but it has been found that such a length is sufficiently long to capture the information in relation to a feature. The skilled person will appreciate that the longer the window, the more the data that is generated resulting in longer processing times and more storage requirements.

The effect of the model parameters, i.e., the number of centroids and HMM states, have been investigated and a value of K=19 and S=24, respectively, were found to be appropriate in the training of the system since these give the smallest standard deviation in the value of the predicted likelihood. It will be appreciated that other embodiments may use different values of K and S. Accordingly, embodiments are arranged to learn the location of the centroids from the data on which the embodiment is trained.

In some embodiments further methods can be used alternatively, or additionally, to create libraries.

### Dynamic Time Warping

In one such embodiment dynamic time warping (DTW) is used. This is method is based on finding a minimum path distance between the frame of reference, Eₛ, and the frame of test, E. Table 5 shows the mean of minimum distance between the acoustic test signals and signatures stored in the library, <C>, and the standard deviation, ∂C, determined with the defect recognition system for the same conditions in the pipe.

TABLE 5
Minimum distance functions between the test signatures
and signatures stored in the library (i.e. pipe
end, blockage and lateral connection)

| File | <C>, (∂C) | | | |
|---|---|---|---|---|
| group | PE | BK | LC | Result |
| PE1 | 0.01 | 0.13 | 0.17 | PE |
| | (0.00) | (0.00) | (0.00) | |
| PE2 | 0.06 | 0.13 | 0.17 | PE |
| | (0.01) | (0.03) | (0.02) | |
| PE3 | 0.04 | 0.12 | 0.17 | PE |
| | (0.02) | (0.01) | (0.01) | |
| PE4 | 0.04 | 0.14 | 0.17 | PE |
| | (0.02) | (0.01) | (0.01) | |
| LC1 | 0.19 | 0.11 | 0.02 | LC |
| | (0.04) | (0.01) | (0.00) | |
| BK1 | 0.13 | 0.04 | 0.11 | BK |
| | (0.01) | (0.02) | (0.01) | |
| BK2 | 0.10 | 0.07 | 0.10 | BK |
| | (0.05) | (0.01) | (0.01) | |

It was found that the variance in the DTW method is small compared to the case of HMM and cross-correlation methods and test signatures were predicted successfully. If the number of training signatures falls below 30 (22% of all available signatures) then the classification error was found to be 4%.

In Dynamic Time Warping the measured data is compressed or stretched in time to have optimal alignment with the defect signature by following time warping procedure which maps both the measured data's time axis and the defect signature's time axis onto a common time axis. Suppose the measured data frame and defect signature frame can be expressed by Eₜ=Eₜ_{₁}, Eₜ_{₂}, . . . , Eₜ_{_{I}} and Eₛ=Eₛ_{₁}, Eₛ_{₂}, . . . , Eₛ_{_{J}}. To align these two sequences using DTW, a I-by-f matrix is constructed where the (i^{th}, j^{th}) element of the matrix contains the distance between the two points Eₜ_{ᵢ} and Eₛ_{ⱼ}. Now to find mapping between Eₜ and Eₛ, warping paths, P, are defined such that the k^{th} element of P is, pₖ=(i,j)ₖ, and, therefore, P={p₁, p₂, . . . , p_{K}}, where max(I, J)K≦I+J−1. The warping path is typically subject to three constraints. The first constraint is boundary condition such that p_{I}=(1,1) and p_{K}=(I,J) which means warping path starts and finishes in diagonally opposite corner cells of the matrix. The second constraint is continuity which restricts the allowable steps in the warping path. For a value of pₖ=(a, b), pₖ₋₁=(c,d) where a−c≦1 and b−d≦1. The last constraint in defining the warping path is monotonicity which forces the points in the warping path to be monotonically spaced in time. For a value pₖ=(a, b), pₖ₋₁=(c−d) where a−c≧0 and b−d≧0. Thus many warping paths can be found that satisfy the above conditions and only the path that minimizes the warping cost can be found from the following equation.

$$D ( i , j ) = d ( {E}_{{t}_{i}} , {E}_{{s}_{j}} ) + min \{ \begin{matrix}D ( i - 1 , j - 1 ) , \\ D ( i - 1 , j ) , D ( i , j - 1 )\end{matrix} \} . \qquad ( 22 )$$

### 2D Cross-Correlation

Some embodiments may use cross-correlation to compare the observed acoustic signature against the library of previously determined acoustic signals. A cross-correlation algorithm used by such embodiments may involve finding the normalized 2-D correlation function (the cross correlator 136 may be arranged to perform this)

$$r ( t , ω ) = \frac{{\int }_{0}^{{ω}_{max}} {\int }_{0}^{{T}_{max}} {e}^{+} ( τ , ϖ ) {e}_{s}^{+} ( t - τ , ω - ϖ ) d τ d ϖ}{\begin{matrix}{\int }_{0}^{{ω}_{max}} {\int }_{0}^{{T}_{max}} {e}^{+} ( τ , ϖ ) {e}^{+} ( t - τ , ω - ϖ ) d τ d ϖ \\ {\int }_{0}^{{ω}_{max}} {\int }_{0}^{{T}_{max}} {e}_{s}^{+} ( τ , ϖ ) {e}_{s}^{+} ( t - τ , ω - ϖ ) d τ d ϖ\end{matrix}} , \qquad ( 23 )$$

where e⁺(t,ω) is the frequency-dependent mean intensity response function calculated from the measured data and eₛ⁺(t,ω) is a mean intensity response function representing a defect signature selected from the signature library 146 (signature database). The bounds in the integrals in expression (23) are selected to ensure that the correlation analysis is carried out over a representative temporal period, Tₘₐₓ, and range of frequencies, ωₘₐₓ, which are sufficient to capture the key features of a particular condition in the sewer pipe. In the above analysis a threshold of r(t, ω) can be set to trigger a match between the recorded data and a signature stored in the signature database 146.

### Library Creation

In other embodiments, the signature library 146 may be loaded into the data storage portion 124 of the memory from a machine readable medium rather than being created as part of an initial training process. It may be that embodiments may be supplied with one or libraries that have previously been created.

Some embodiments may be used to determine the degree of change which a section of a pipe has experienced over time. Such operational and structural changes are often not localised and occur gradually along the whole length of the pipe 22 resulting from the development of longitudinal cracks, continuous sedimentation, or the like. It will be appreciated that at some critical instant a small change can result in a service failure (which may then contribute to a flood event caused by a blockage or a structural pipe collapse) and embodiments that monitor a pipe over time may be able to identify a defect before it reaches this critical point. In such embodiments reading may be taken from time to time. For example, readings may be taken weekly, monthly, quarterly, every 6 months, yearly, or the like. In other embodiments readings may be taken on a substantially continuous basis.

The acoustic impulse response recorded in the pipe 22 can also be used to determine the level of water or wet sediment above which the sensor is installed. The level of water or wet sediment affects the frequencies of cross-sectional modes that can propagate in the pipe. At the frequencies corresponding to the cross-sectional modes the modal phase velocity is close to the infinity and the acoustic field in the pipe has characteristic maxima that can be detected with a narrow-band frequency analysis. The filter unit 128 may be arranged to perform at least a portion of this analysis. In this way the resonance peaks in the frequency spectra in the recorded acoustic impulse response can be related to the water/sediment level.

FIG. 5 shows the spectrogram of the acoustic intensity response obtained in the laboratory for a 14.8 m long, 150 mm diameter clay pipe with a 25% blockage. The spectrogram shows two clear reflections: at 8 m 600 from the sensor and at 14.6 m 602 from the sensor. These reflections correspond to the blockage 600 and open end of the pipe 602, respectively. Embodiments, may take the spectrogram as shown in FIG. 5 and generate two portions from it; a first portion relating to the blockage 600 and a second portion relating to the pipe end 602. Each of these portions may then be compared against the library of acoustic signatures to determine the pipe feature that that portion of the acoustic signature represents.

Table 2 presents the statistical data on performance of the two cross-correlation pattern recognition and classification methods presented above: 2D cross-correlation and the hidden Markov Model. This algorithm was applied to the acoustic data collected in the 150 mm pipe from 30 independent experiments. The following abbreviations are adopted here: PE—pipe end; BK—blockage; LC—lateral connection. The presented data for <r> correspond to the percentage of correct classifications, which is the ability of the cross-correlation algorithm to match the data with a particular condition in the presence of a variable flow level, variable sensor position and intermediate artefacts introduced into the path of the propagated acoustic wave. ∂r corresponds to the standard deviation in the cross-correlation data taken over the whole range of experiments.

TABLE 2
Performance of the cross-correlation algorithm.
Cross-correlation of test signatures with the signatures stored
in the library (i.e. pipe end, blockage and lateral connection)

| File | <r> (∂r) | | | |
|---|---|---|---|---|
| group | PE | BK | LC | Result |
| PE1 | 99.84 | 31.23 | 35.59 | PE |
| | (0.1) | (2.26) | (2.60) | |
| PE2 | 80.32 | 42.18 | 35 | PE |
| | (5.80) | (11.29) | (2.53) | |
| PE3 | 85.56 | 29.69 | 27.64 | PE |
| | (28.81) | (4.06) | (12.45) | |
| PE4 | 96.27 | 29.21 | 32.88 | PE |
| | (9.39) | (2.55) | (2.77) | |
| LC1 | 79.17 | 90.03 | 99.90 | LC |
| | (2.40) | (0.32) | (0.04) | |
| BK1 | 68.67 | 98.98 | 50.92 | LC |
| | (9.58) | (1.10) | (26.40) | |
| BK2 | 89.16 | 93.1 | 83.87 | LC |
| | (8.80) | (3.15) | (13.80) | |

Table 3 presents the data which illustrate the ability of the hidden Markov model to identify three different conditions in a 150 mm clay pipe. The presented numerical values correspond to the logarithmic measure of the likelihood calculated for the guessed condition according to the method detailed above. The smaller the value of log<P(y|λₘ)>, the smaller the likelihood that the data would match that particular condition. The standard deviation in the likelihood, ∂P(y|λₘ), corresponds to the variability in P(y|λₘ) taken over the range water flow levels, sensor positions and intermediate conditions in the pipe.

TABLE 3
Performance of the hidden Markov models.
Likelihood of test signatures with three Hidden Markov
Models (i.e. pipe end, blockage and lateral connection)

| File | <P(y \| λ)>, (∂P(y \| λ)) | | | |
|---|---|---|---|---|
| group | PE | LC | BK | Result |
| PE1 | −4.52 | −218 | −32.75 | PE |
| | (0.78) | (3.6) | (1.37) | |
| PE2 | −29.44 | −177.86 | −37.51 | PE |
| | (3.61) | (50.35) | (8.78) | |
| PE3 | −17.25 | −220.32 | −33.04 | PE |
| | (2.65) | (7.09) | (3.77) | |
| PE4 | −16.28 | −219.81 | −32.64 | PE |
| | (2.10) | (3.85) | (4.28) | |
| LC1 | −210.87 | −17.78 | −22.67 | LC |
| | (0.17) | (1.74) | (2.73) | |
| BK1 | −22.70 | −138.34 | −17.85 | BK |
| | (1.80) | (72.52) | (0.98) | |
| BK2 | −68.50 | −161.68 | −19.57 | BK |
| | (84.44) | (46.54) | (1.20) | |

Results of tests show that embodiments using the cross-correlation algorithm were able to recognise correctly 67% of the lateral connection and pipe end conditions and further show that embodiments using the hidden Markov model were more robust because they recognised correctly 94% of these conditions.

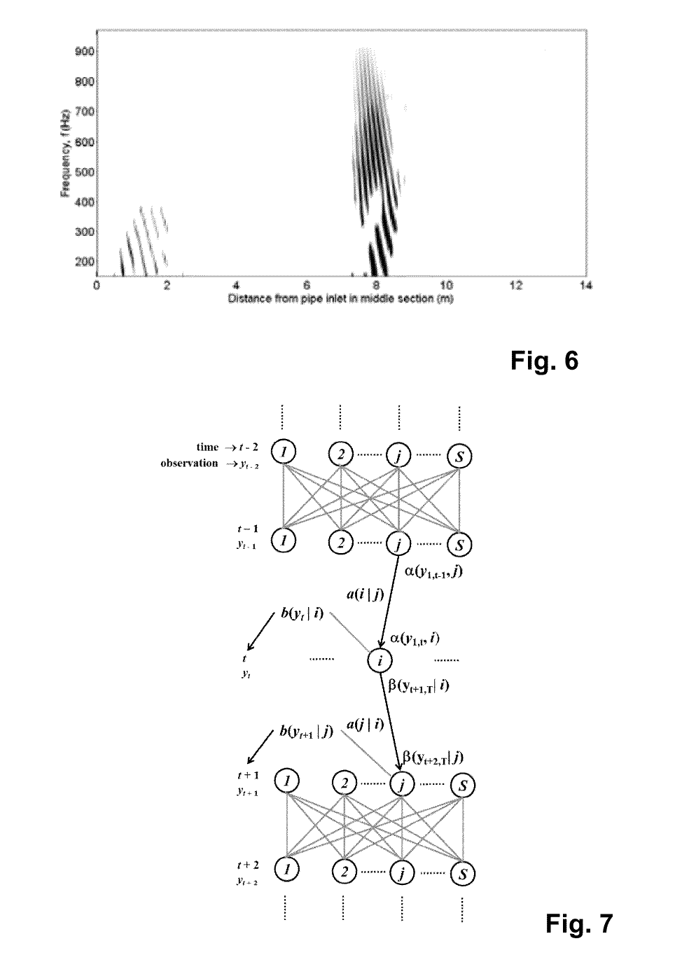

Thus, embodiments may utilise one of a number of techniques for identifying the acoustic signature as for example shown in FIGS. 4 to 6. In addition to the 2D cross correlation; the Hidden Markov Models; and the Dynamic Time Warping techniques described herein there may be other pattern recognition and condition classification techniques.

Some embodiments which have a signature library generated from more than one processing technique may also comprise a decision module 150 which is arranged to process a plurality of different models in order to increase the confidence that the correct acoustic signature has been identified within one of the signature libraries to represent the true condition within the pipe 22 (i.e., that the correct features have been detected). The decision module may for instance comprise a voting module arranged to vote on which of the acoustic signatures is most likely to be correct. The voting module may be arranged to weight, or otherwise score, the determination of the condition of the pipe from each of the libraries against which a comparison was made.

Embodiments may be arranged to monitor developing of blockages, perhaps in order to determine when intervention is needed.

Further embodiments may be used to calibrate better the numerical tools for modelling the hydraulic flow used in the design and/or operation of sewers (or other pipe work systems).

Thus, embodiments may provide a method of inspecting a pipe which is remote and/or non-invasive.

Further, embodiments, unlike the CCTV inspection, may provide a method for which the speed of inspection is irrespective of the length of the pipe and may only be limited by the speed with which the acoustic data can be communicated and processed.

Embodiments of the invention may allow a pipe to be analysed within a time frame of roughly one minute.

At least some embodiments of the invention allow a length of pipe to be inspected from a single access point. Such embodiments are thus easier to use than systems that require access to two access points, such as two man-holes, or the like.

Conveniently embodiments, utilise frequencies which are below the first cross-sectional mode of the pipe.

The aspects and features of the present invention are described hereinafter with reference to flowchart illustrations of user interfaces, methods, and computer program products according to exemplary embodiments. It will be understood that each block of the flowchart illustrations, and combinations of blocks in the flowchart illustrations, can be implemented by computer program instructions (whether in firmware or software) or indeed provided by hardware. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

We claim:

1. A method of inspecting pipes to determine features thereof, the method comprising:
deploying an apparatus in a pipe or close to an end region of the pipe;
emitting an acoustic signal from the apparatus;
detecting reflected acoustic signals with a detector array of the apparatus and determining an acoustic intensity from the detected acoustic signals;
analysing the acoustic intensity signals to derive one or more portions thereof with each portion relating to a feature of the pipe;
determining an acoustic signature for each of the portions of the intensity signals;
comparing the or each acoustic signature against at least one library of previously determined acoustic signals; and
determining, from the comparison, the condition of the pipe being inspected.

2. A method according to claim 1, in which the acoustic signature comprises data providing the intensity of the received acoustic signal at a given frequency at distance along the pipe being inspected.

3. A method according to claim 1, in which the analysing performed on the reflected acoustic signals includes dividing those reflected signals into a plurality of frequency bands.

4. A method according to claim 3, in which the acoustic signature is comprised of a plurality of sub-signatures, each of which is formed by one of the plurality of frequency bands.

5. A method according to claim 1, in which one or more statistical techniques is used to make the comparison with the signature library.

6. A method according to claim 5, in which a plurality of statistical techniques is used and a further comparison is performed to combine the comparisons.

7. A method according to claim 6, in which the further comparison includes using a weighting to determine which signature from one of the signature libraries should be selected.

8. A method according to claim 1, which is arranged to generate the at least one signature library from a series of sample data generated from reflected acoustic signals.

9. A method according to claim 8, which is arranged to learn parameters from the sample data and these parameters are used to form the at least one signature library.

10. A method according to claim 1, in which at least one signature library comprises one of the following: Hidden Markov Models; Acoustic signatures; Dynamic Time Warping.

11. A method according to claim 1, in which each library contains data relating to a plurality of any of the following: pipe diameters; pipe materials.

12. A method according to claim 1, comprising:
retrieving a first data file, associated with the condition of the pipe being inspected at an earlier time;
comparing a condition of the pipe at the earlier time with the current condition of the pipe; and
determining, from the comparison, the condition of the pipe being inspected.

13. A method according to claim 12, comprising:
using the comparison of the first data file and the current pipe condition to determine at least one of the following:
that the pipe should be replaced;
that the pipe should be re-inspected after a time interval has elapsed; and
that further detailed inspection of the pipe is required.

14. A method according to claim 12, comprising:
generating a second data file, associated with the current condition of the pipe; and
outputting the second data file.

15. A method according to claim 13, comprising:
generating a second data file, associated with the current condition of the pipe; and
outputting the second data file.

16. A method according to claim 14 comprising storing the second data file in association with the first data file.

17. A method according to claim 15 comprising storing the second data file in association with the first data file.

18. An apparatus arranged to inspect a pipe, wherein the apparatus comprises
a sound emitter arranged to emit an acoustic signal;
a detector array configured to detect acoustic signals;
a signal processor arranged to
i) determine acoustic intensity signals from the received detected acoustic signal;
ii) analyse the acoustic intensity signal to derive one or more portions thereof with each portion relating to a feature of the pipe;
iii) determine an acoustic signature for each of the portions of the intensity signals;
iv) compare the, or each, acoustic signature against a library of previously determined acoustic signals; and
v) determine, from the comparison, the condition of a pipe being inspected.

19. A non-transitory computer-readable medium storing executable computer program code for inspecting pipes, the computer program code executable to perform steps comprising:
emitting an acoustic signal from the apparatus;
detecting reflected acoustic signals with a detector array of the apparatus and determining an acoustic intensity from the detected acoustic signals;
analysing the acoustic intensity signals to derive one or more portions thereof with each portion relating to a feature of the pipe;
determining an acoustic signature for each of the portions of the intensity signals;
comparing each acoustic signature against at least one library of previously determined acoustic signals; and
determining, from the comparison, the condition of the pipe being inspected.
